(19) United States
(12) Patent Application Publication
(10) Pub. No.: US 2007/0092745 A1
(43) Pub. Date: Apr. 26, 2007

(54) Thermotolerant starch-polyester composites and methods of making same

(76) Inventors: Li Nie, Parkville, MO (US); Michael D. Parker, Lawrence, KS (US); Sukh D. Bassi, Atchison, KS (US); Clodualdo C. Maningat, Platte City, MO (US)

Correspondence Address: LATHROP & GAGE LC, 4845 PEARL EAST CIRCLE, SUITE 300, BOULDER, CO, 80301, US

(21) Appl. No.: 11/585,369

(22) Filed: Oct. 24, 2006

Related U.S. Application Data
(60) Provisional application No. 60/729,584, filed on Oct. 24, 2005.

(51) Int. Cl. B32B 27/36; D21H 19/54

(52) U.S. Cl. 428/480; 524/47

(57) ABSTRACT

Starch-polyester blends are disclosed herein. The composite formulations have improved thermotolerance and workability, relative to polyesters used alone, so that they may be molded into disposable items for heat related applications. For example, composite products may include cutlery, cups, plates, bowls, packaging and the like.

### RELATED APPLICATIONS

This application claims priority to U.S. application No. 60/729,584, filed Oct. 24, 2005, which is incorporated herein by reference.

### FIELD OF THE INVENTION

The present invention relates to starch-polyester composites, and methods of preparing the same. The disclosed starch-polyester composites show excellent stability toward thermal distortion.

### BACKGROUND

Polylactic acid (PLA) is a polyester that is attractive as a sustainable alternative to petrochemically-derived products. Lactic acid, from which PLA is produced, can be derived from the fermentation of agricultural products such as starch-rich substances like corn, maize, sugar or wheat. Polylactic acid exhibits good flexibility, scratch resistance, high gloss and clarity and excellent tensile stress characteristics. Semicrystalline PLA is, however, known for its low thermal distortion temperature of about 58° C. This property, as well as the fact that PLA is sticky and difficult to mold, has prevented the commercialization of disposable PLA products for use with hot foods.

Research efforts to improve the thermal distortion temperature of PLA have involved the use of nucleating agents to increase the rate of crystallization of semicrystalline PLA and/or blending of PLA with other biodegradable polyesters that do not significantly change the properties of PLA.

### SUMMARY

The subject matter of the present disclosure advances the art and overcomes the problems outlined above by providing starch-polyester composites and methods for their manufacture. It has been discovered that composites of starch with polyesters, and in particular PLA, annealed for a specific duration at a proper temperature, produce composite products with significantly improved thermal deformation tolerance of above 120° C. (ASTM D648). The composites also possess improved molding or other thermal forming properties, and significantly increased biodegradation rates relative to PLA alone. The composite products disclosed herein typically have no surface shine.

Satisfactory products cannot be made without a minimum amount of starch, which may be used alone or in combination with fibers and fillers. The total amount of starch, filler and fiber is at least 35% by weight; otherwise, the products can stick and warp making annealing impossible.

Between about 25% and 75% granulated starch may be combined with semicrystalline PLA and a compatibilizer. For example, the compatibilizer may be about 2-8% maleated PLA. The maleated PLA is added in the formulation to dramatically improve the mechanical properties of the composites. Maleation of PLA must be conducted above 200° C. in a reactive extrusion process to obtain satisfactory results. Maleation at 220-240° C. has been found to provide very good mechanical properties in the disclosed starch-PLA composites. Annealing of the composites can be conducted at temperatures from about 90-120° C. for 10-30 minutes. In contrast, composites made without starch cannot be properly annealed because PLA tends to stick, shrink, and/or warp.

Starches used in the disclosed formulations may be unmodified granular starches, gelatinized starches, and/or chemically or genetically modified starches. Virtually any starch can be used in the presently disclosed composite formulations, including starches selected from the group consisting of cereal, root, tuber and legume. Further, suitable starches include those selected from wheat, waxy wheat, corn, waxy corn, high amylose corn, oat, rice, tapioca, mung bean, sago, sweet potato, potato, barley, triticale, sorghum, banana and other botanical sources including waxy, partial waxy, and high amylose variants (“waxy” being intended to include at least about 95% by weight amylopectin, and “high amylose” being intended to include at least about 40% by weight amylose). Chemically, physically or genetically modified forms of starches can also be used. Modification techniques include 1) treatment with chemicals and/or enzymes according to 21 CFR 172.892; 2) physical transformations such as retrogradation (recrystallization), heat treatment, partial gelatinization, annealing and roasting; 3) genetic modifications including gene or chromosome engineering, such as cross-breeding, translocation, inversion and transformation; and 4) combinations of the above.

Fillers or fibers can be added to the formulation. These may include wood fiber, cellulose fiber, cotton fiber, sisal fiber, jute fiber, glass fiber; mineral fillers such as talc, mica, calcium carbonate, clays, and nanoclays; and pigments such as titanium dioxide, iron oxide red, carbon black, organic pigments, etc. Notably, wood fiber, cellulose fiber, cotton fiber and glass fiber can react with maleated PLA and provide fiber reinforcement.

The amount of fiber in the formulation is typically less than about 30%. The presence of fibers can provide dimensional stability which further improves heat distortion temperatures obtained after the annealing process. The amount of filler is typically less than about 15%. The amount of pigment or dye is typically less than about 5%.

Polyester plasticizers may also be included in the disclosed formulations in a range of from about 0-10% by weight. Suitable plasticizers include ester derivatives of such acids and anhydrides as adipic acid, azelaic acid, benzoic acid, citric acid, dimer acids, fumaric acid, isobutyric acid, isophthalic acid, lauric acid, linoleic acid, maleic acid, maleic anyhydride, melissic acid, myristic acid, oleic acid, palmitic acid, phosphoric acid, phthalic acid, ricinoleic acid, sebacic acid, stearic acid, succinic acid, 1,2-benzenedicarboxylic acid, and the like, and mixtures thereof. Also suitable are epoxidized oils, glycerol derivatives, paraffin derivatives, sulfonic acid derivatives, and the like, and mixtures thereof.

### EXAMPLE 1

### Typical Malaetion Formulations and Conditions

Formulations for production of maleated polylactic acid typically contain:
1-3% maleic anhydride
0.05-1.0% peroxide
97-99% PLA

The extrusion temperature is typically about 210-250° C. Screw speed typically varies from 50 to 400 rpm. Extruder barrel length may be 20-48 L/D. Single or twin screw extruders can be used.

### EXAMPLE 2

### Maleation of Polylactic Acid (PLA)

Maleic anhydride powder (2.5 parts) was mixed with dicumyl peroxide (0.5 parts). PLA (97 parts) was fed into the main feed hopper on a ZSE-40 Berstorff co-rotating twin screw extruder with a 40 L/D barrel length to screw diameter ratio. The extruder barrel was set at 220° C. for all barrels. Maleation was conducted at 250 lbs/hr with screws running at 250 rpm. The melt was strand palletized. Pellets typically had a yellowish color. Maleated PLA had a lower melt index than the PLA used to make the maleated product.

When maleic anhydride was used at a level of 0.25-3.0%, a melt index of about 1-100 was obtained by testing method ASTM D1238.

### EXAMPLE 3

### Typical Starch-polyester Composite Formulations

A typical starch-polyester composite resin formulation contains:

| | |
|---|---|
| Starch | 25-75% |
| Semicrystalline PLA | 20-74% |
| Maleated PLA | 1-6% |
| Cellulose | 0-20% |
| Wood fiber | 0-20% |
| Glass fiber | 0-20% |
| Mineral fillers | 0-10% |
| Pigments and dye | 0-3% |
| Plasticizers for PLA | 0-10% |

### EXAMPLE 4

### Starch-polylactic Acid Composite Made by Compounding

| | |
|---|---|
| Wheat Starch (predried to less than 3% moisture) | 60 parts |
| Semicrystalline PLA 5060* | 46 parts |
| Maleated PLA (see Example 2) | 4 parts |

*Supplied by Nature Works.

Compounding was conducted on a ZSE-40 twin screw extruder with a 40 L/D barrel length to screw diameter ratio, a rate of 250 lbs/hr and with screws running at 250 rpm. Barrel temperature was set to 200° C. in plasticating zones, 180° C. in the mixing zone and 160° C. toward the die end. PLA and maleated PLA were fed to the main feeding hopper. Starch was fed by a side feeder. Two venting ports were provided for ease of starch feeding and moisture removal. The die end venting port was equipped with a vacuum vent stuffer. The melt was cut into pellets with a Gala MB 500 underwater pelletizer. The pellets moved though a shaker screen cooler before being collected into bags and Gaylords.

Compound resins produced as described above can be used directly for injection molding or sheet extrusion. Resin can also be diluted with virgin PLA to lower the starch content of the resin.

### EXAMPLE 5

### Starch-Polylactic Acid Composite Containing Cellulose Fiber Made by Compounding

| | |
|---|---|
| Wheat Starch (predried to less than 3% moisture) | 40 parts |
| Cellulose Fiber* | 20 parts |
| Semicrystalline PLA** | 46 parts |
| Maleated PLA made by example 1 | 4 parts |

*SC 180 provided by Creafill
**Supplied by Nature Works

Compounding was conducted as described in Example 4.

### EXAMPLE 6

### Injection Molding and Thermoforming

Disposable products, such as cutlery, can be injection molded using a conventional injection molding press. Molding can be done with the barrel temperature set at 160-200° C. The mold temperature can be from room temperature to 55° C.

Disposable products such as plates, bowls, cups, etc, can be made by thermoforming. The molding temperature can be kept at 90-170° C. during heating. Cooling can be done at less than 55° C.

### EXAMPLE 7

### Product Annealing

The products can be annealed at from 90-120° C. for 10-30 minutes. For example, at 100° C, 15 minutes of annealing increased the thermal distortion temperature of the compound resin made in Example 4 to above 141° C., at 66 PSI (ASTM D648), while typical PLA has a thermal distortion temperature of only 58° C. An annealed tensile specimen had a tensile strength of 49.3 MPa and a tensile modulus of 2,094 MPa. Adding fiber to the formulation also helped to improve the thermal distortion temperature due to the reinforcing effects of fiber.

The products can be annealed individually on a bed or moving belt, or stacked during annealing. After annealing, the products are cooled to room temperature.

Changes may be made in the above compositions and methods without departing from the invention described in the Summary and defined by the following claims. It should thus be noted that the matter contained in the above description or shown in the accompanying drawings should be interpreted as illustrative and not limiting.

All references cited are incorporated by reference herein.

1. A composite product with a heat distortion temperature of at least 120° C., comprising:
semicrystalline polylactic acid (PLA);
starch; and
a compatibilizer.

2. The product of claim 1, further comprising one or more of cellulose fiber, cotton fiber, wood fiber, sisal fiber, jute fiber, glass fiber, mineral fillers, and a pigment.

3. The product of claim 2, wherein the amount of cellulose fiber, cotton fiber, wood fiber, sisal fiber, jute fiber, and glass fiber ranges from about 0-30% by weight.

4. The product of claim 2, wherein the mineral filler is selected from the group consisting of clays, nanoclays, talc, mica, calcium carbonate, and combinations thereof.

5. The product of claim 4, wherein the mineral filler ranges from about 0-15% by weight.

6. The product of claim 2, wherein the pigment is selected from the group consisting of titanium dioxide, iron red, carbon black, organic pigments, and combinations thereof.

7. The product of claim 6, wherein the pigment ranges from about 0-5% by weight.

8. The product of claim 2, wherein a total amount of starch, cellulose fiber, cotton fiber, wood fiber, sisal fiber, jute fiber, glass fiber, and mineral filler is at least 35% by weight of the product.

9. The product of claim 1, further comprising a plasticizer.

10. The product of claim 8, wherein the plasticizer ranges from 0-10% by weight.

11. The product of claim 1, wherein the starch is present in a range of from about 25-75% by weight.

12. The product of claim 1, wherein the semicrystalline PLA is present in a range of from about 20-75% by weight.

13. The product of claim 1, wherein the compatibilizer is present in a range of from about 1-10% by weight.

14. The product of claim 1, wherein the compatibilizer is maleated PLA.

15. The product of claim 1, wherein the semicrystalline PLA has a melt index of 0.1-100 using ASTM D1238 testing method.

16. The product of claim 1, wherein the product has a tensile strength of at least 30 MPa and a tensile modulus of at least 1,000 MPa.

17. A method of preparing a thermotolerant starch-polyester composite, comprising the steps of:
mixing semicrystalline PLA, starch and maleated PLA;
compounding the mixture at a temperature of about 120-220° C.;
molding the compounded mixture into the shape of a final product; and
annealing the final product at a temperature of from about 90-120° C. for 10-30 minutes.

18. The method of claim 17, wherein the annealed product has a thermal distortion temperature above 120° C.
